(19) United States
(12) Patent Application Publication
(10) Pub. No.: US 2006/0126530 A1
(43) Pub. Date: Jun. 15, 2006

(54) Indicating a configuring status

(75) Inventors: Daniel Fuhrmann, Koln (DE); Andreas Wannenwetsch, Dusseldorf (DE); Thomas Nagelkramer, Kuerten (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/142,359

(22) Filed: Jun. 2, 2005

(30) Foreign Application Priority Data
Dec. 14, 2004 (EP) 04029517.2

(51) Int. Cl. H04J 1/16; H04L 12/28

(52) U.S. Cl. 370/252; 370/254

(57) ABSTRACT

This invention relates to a method for indicating a status of a configuring of a network element, said method includes checking (300, 301) if all configurations of a pre-defined set of configurations for said network element (3, 3a) have been conducted. The pre-defined set of configurations is smaller than a set of configurations that comprises all possible configurations for said network element (3, 3a). The method also indicates (302) an incomplete configuring of said network element (3) when said checking (300, 301) reveals that not all configurations of said pre-defined set of configurations have been conducted. The invention further relates to a computer program, a computer program product, a device, a network element, and a system.

### BACKGROUND OF THE INVENTION

1. Field of the Invention

This invention relates to a method for indicating a status of a configuring of a network element, and a corresponding computer program, computer program product, device, network element and system.

2. Description of the Related Art

The commissioning of network elements in communications systems is generally considered the most essential part in the roll-out of wireless and wire-bound networks. For instance, if the network is a mobile radio communications system or a part thereof, the network elements may be nodes in the radio access network and the core network of the mobile radio system, such as for instance base stations, radio network controllers or intermediate transmission nodes as examples of nodes in a radio access network and mobile-services switching centres and serving general packet radio system support nodes as examples of nodes in a core network.

The commissioning takes place after a network element has been physically installed in its operational area and particularly comprises the configuring of the network element. Generally, a plurality of configurations, which are understood as definitions of one or more system parameters related to specific functions or properties of said network element throughout this specification, have to be conducted to guarantee a proper functioning of said network element.

These configurations are usually conducted by a commissioning engineer during the commissioning of the network element. Network elements tend to become more and more complex, so that the number of configuration possibilities is steadily increasing.

Erroneous or missing configurations in network elements may substantially affect the functioning of network elements. It is then frequently difficult to decide if a network element is actually broken or only wrong configured, thus leading to an increased number of network elements that are returned from the field to the manufacturer marked as “defect” network elements, although a comparatively simple re-configuration would have removed the malfunctioning of the network element.

To support the commissioning engineer during the commissioning of the network element, commissioning checklists are used in prior art. These printed or electronic checklists contain an enumeration of all tasks that have to be performed during the commissioning, including all configurations that are possible for the network element and have to be conducted.

Furthermore, prior art document EP 1 005 216 proposes a method for validating configuration data before applying said configuration data to a telecommunications system. Therein, configuration data has to obey specific validation rules, which are checked before said configuration data is applied to said telecommunications system. An example of such a validation rule is a check whether said configuration data contains only telephone numbers with exactly six digits.

In the above-discussed prior art approaches, it is always set out from the assumption that all configurations that are possible for the network element should be conducted during commissioning. However, not all system parameters required for the configuring of the network element may be known to the commissioning engineer, there may not be enough time to conduct all possible configurations for said network element, and or the commissioning engineer may simply overlook a configuration or may forget to perform a configuration, but nevertheless check it on one of said checklists. This leads to a particularly delicate configuration state of the network element, because the importance of single configurations missing due to said lack of knowledge of system parameters, said lack of time, said overlooking or said oblivion of configurations generally turns out only during the operation of said network element. The success of the commissioning of a network element then vastly depends on the skills, experience and power of concentration of the commissioning engineer.

### SUMMARY OF THE INVENTION

In view of the above-mentioned problems, it is, inter alia, an object of the present invention to provide a method, a computer program, a computer program product, a device, a network element and a system that allows for a more robust and less error-prone configuring of a network element.

A method is proposed for indicating a status of a configuring of a network element, said method comprising checking if all configurations of a pre-defined set of configurations for said network element have been conducted, wherein said pre-defined set of configurations is smaller than a set of configurations that comprises all configurations that can be conducted for said network element; and indicating an incomplete configuring of said network element in case said checking reveals that not all configurations of said pre-defined set of configurations have been conducted.

Said network element may be any functional unit of a network. Said network may for instance be any wire-bound or wireless telecommunications system, or any wire-bound or wireless data transmission system such as a wire-bound or wireless local or wide area network. If said network is the Universal Mobile Telecommunications System (UMTS), said network elements may be nodes in a Radio Access Network (RAN) or Core Network (CN) of said UMTS, as for instance a Node B, a Radio Network Controller (RNC), an intermediate transmission node, a Mobile-Services Switching Center (MSC) or a CN gateway.

For said network element, a plurality of configurations can be conducted, wherein said plurality of configurations are contained in said set of configurations, which also comprises said pre-defined set of configurations. Therein, a configuration for said network element is conducted by defining one or more system parameters related to a specific function or property of said network element. For instance, a synchronization-related configuration for said network element may be conducted by defining a synchronization source and a synchronization mode. Said configuring of said network element is understood as a process of conducting at least one configuration for said network element.

According to the present invention, a set of configurations, that is smaller than said set of configurations that comprises all configurations that can be conducted for said network element, has been defined before said configuring of said network element. Said pre-defined set of configurations may for instance contain only those configurations that are considered important for an operation of said network element.

Instead of checking if all possible configurations that actually can be conducted for said network element have been conducted, according to the present invention, it is only checked if all configurations of said pre-defined set of configurations have been conducted, and if this is not the case, an incomplete configuring of said network element is indicated, for instance via a graphical user interface that assists a user during a configuring of said network element. Said configurations of said pre-defined set of configurations may have been conducted before and/or during said actual configuring of said network element. In said checking, a configuration may be considered to have been conducted if any system parameter related to said configuration has been defined. Equally well, in said checking, a configuration may be considered to have been conducted only if said configuration is operative.

Said checking and said indicating may be performed automatically. Said checking and/or indicating may for instance be performed during said configuring of said network element, for instance during a commissioning or a maintenance of said network. Said checking and/or said indicating may for instance be performed in real-time.

Said checking may be performed repeatedly during said configuring of said network element, for instance each time when a new configuration has been conducted, and said indicating of said incomplete configuring may be indicated as long as not all configurations of said pre-defined set of configurations have been performed. Thus when said incomplete configuring is no longer indicated, a user can be sure that all configurations of said pre-defined set of configurations have been conducted to ensure a proper operation of said network element.

In contrast to known configuring techniques, that either target that all possible configurations are conducted or check a correctness or consistency of the configuration data, the present invention sets out from a pre-defined set of configurations that may be substantially smaller than said set of all possible configurations that are actually to be conducted during the configuring of said network element, and thus ensures that at least the configurations contained in said pre-defined set of configurations are conducted for said network element. As an incomplete configuring is indicated in case that not all configurations of said pre-defined set of configurations have been conducted, the configuring of said network element becomes more robust and less error-prone.

According to an embodiment of the present invention, said configurations in said pre-defined set of configurations are considered important for an operation of said network element. Such a set of configurations may then for instance be determined by simulation of networks that comprise said network element, or may be based on experience.

According to a further embodiment of the present invention, said checking if all configurations of said pre-defined set of configurations for said network element have been conducted comprises checking if at least one configuration of said pre-defined set of configurations is operative, wherein said at least one configuration of said pre-defined set of configurations is only considered to have been conducted if it is operative. Said operativeness may for instance be checked by plausibility checks, for instance by checking if system parameters defined when a configuration is conducted obey a certain format, e.g. comprise only numbers, have a certain number of digits or follow a pre-defined syntax. Said check for operativeness then can be considered as a check for correctness of said configurations. Equally well, said operativeness may be checked by determining if a specific function that is related to system parameters that are defined when said configuration is conducted is operative. Such a check may then for instance be performed in real-time. For instance, if a synchronization-related configuration is conducted by defining a synchronization source and mode, said configuration is operative when said synchronization source can be found by said network element and if said network element can be synchronized by said synchronization source in the defined synchronization mode. Only considering said at least one configuration to have been conducted when it is operative further increases the robustness of the configuring of said network element, as it is not only checked if said at least one configuration has been conducted in any (potentially wrong) way, but in a way that leads to an operative configuration. Among said pre-defined set of configurations, then there may exist two sub-sets: one sub-set of configurations for which operativeness is checked and required, and one sub-set of configurations for which operativeness is not checked and not required. Of course, also the case that operativeness is checked for all configurations in said pre-defined set of configurations, and the case that operativeness is checked for none of the configurations in said pre-defined set of configurations are envisaged by the present invention.

According to a further embodiment of the present invention, said checking if all configurations of said pre-defined set of configurations for said network element have been conducted and said indicating of an incomplete configuring of said network element in case said checking reveals that not all configurations of said pre-defined set of configurations have been conducted are performed automatically during said configuring of said network element. By performing the checking and indication during said configuring of said network element, it is ensured that said indication of an incomplete configuring of said network element is always up to date during said configuring. For instance, if said configuring is performed during a commissioning of said network element, a user that conducts configurations may always be informed if at least the configurations in said pre-defined set of configurations have been completed or not, for instance if said checking and indicating are repeated each time after a new configuration has been conducted. Furthermore, said checking and indicating is performed automatically. This may for instance mean that said checking and indicating takes place completely without user interaction as soon as said configuring of said network element is started. Equally well, said automatic performance of said checking and indication may only take place after a user has allowed or activated said checking and indicating, for instance from a menu offered by a configuring device. Said automatic performance of said checking and indicating may also comprise the case that said checking and indicating are performed in response to a pre-defined number of conducted configurations, for instance after each single conducted configuration. In all of these cases of automatic checking and indicating, a user then only may have to care for the conducting of the configurations, and not for the checking and indicating, but the incomplete configuring status is nevertheless indicated to him in case an incomplete configuring of said network element is determined during said checking. As an alternative to said automatic checking and indicating, a user may manually trigger said checking and indicating, for instance in certain intervals or before a configuring of said network element is to be terminated. The checking and indicating then may for instance be triggered by hitting a button or selecting a menu option.

According to a further embodiment of the present invention, said indicating of said incomplete configuring of said network element is performed as long as said checking reveals that not all configurations of said pre-defined set of configurations have been conducted. By indicating said incomplete configuring of said network element as long as not all configurations of said pre-defined set of configurations have been conducted, a user is always aware of the configuring status of said network element.

According to a further embodiment of the present invention, said checking if all configurations of said pre-defined set of configurations for said network element have been conducted is repeated each time a configuration for said network element has been conducted. The configuring status of said network element then may be only updated after each new configuration, and processing power required for the checking can be saved. Alternatively, said checking may be performed periodically or be triggered by other, possible external events like user interaction or the like.

According to a further embodiment of the present invention, said method is performed during a commissioning of said network element. During said commissioning, a commissioning engineer conducting said configurations then is always aware if all configurations of said pre-defined set of configurations have been performed to ensure proper functioning of said network element.

According to a further embodiment of the present invention, said method is performed during a maintenance of said network element. Said maintenance may for instance relate to an exchange of hardware and/or software components of said network element that requires a change in the configurations of said network element. It is then again checked if all configurations of said set of configurations have been conducted for said network element, possibly setting out from a pre-defined set of configurations that has been adapted to the new hardware and/or software components of said network element. Said maintenance may also be required after a separation of said network element from a power source or any other malfunctioning or damage of said network element.

According to a further embodiment of the present invention, said incomplete configuring of said network element is indicated via a graphical user interface that is used for said configuring of said network element. There may for instance be a message in said graphical user interface indicating said incomplete configuring, or any other type of graphical indication.

According to a further embodiment of the present invention, said incomplete configuring of said network element is indicated via a dedicated graphical element of said graphical user interface. Said graphical element may for instance be an element in a tool bar of a graphical user interface.

According to a further embodiment of the present invention, said method further comprises indicating a complete configuring of said network element if said checking reveals that all configurations of said pre-defined set of configurations have been conducted. Said indicating of said complete configuring may for instance correspond to said indicating of said incomplete configuring, there may for instance be a red sign indicating said incomplete configuring, and a green sign indicating said complete configuring.

According to a further embodiment of the present invention, said method further comprises displaying, on demand, a list of those configurations of said pre-defined set of configurations that not have been conducted yet. A user then can always check back which configurations of said pre-defined set of configurations still have to be conducted. Said list of configurations may for instance be demanded by clicking a button on a tool bar of a graphical user interface, wherein said button may for instance be a button that also indicates said incomplete configuring of said network element.

According to a further embodiment of the present invention, said method further comprises displaying a list of those configurations of said pre-defined set of configurations that not have been conducted when said configuring of said network element is terminated. This is advantageous at least in two situations: In a first situation, the user may not be able to conduct all configurations, and thus said list may concisely present the configurations that the user has to gather further information on. In a second situation, the user may be a skilled user and may decide to dispense with at least some of said configurations of said pre-defined set of configurations, for instance because these configurations are not necessarily required in the present case. The list then serves as a final opportunity for the skilled user to check if he overlooked one configuration of said pre-defined set of configurations.

According to a further embodiment of the present invention, said method further comprises displaying a configuration dialogue that assists a user in a conducting of at least one configuration of those configurations of said pre-defined set of configurations that not have been conducted yet, if said at least one configuration is selected from said list. It is then possible to directly conduct the required configurations instead of having to select the configuration that has to be changed first and then only to conduct said configuration.

It is further proposed a computer program with instructions operable to cause a processor to perform the above-described method steps. Said processor may for instance be a part of said network element. It may equally well be a part of a configuration device such as a lap-top computer or a similar device, which can be hooked to said network element via an interface to conduct the configurations.

It is further proposed a computer program product comprising a computer program with instructions operable to cause a processor to perform the above-described method steps. Said computer program product may for instance be any electrical, optical or magnetic storage medium.

It is further proposed a device, said device comprising means arranged for checking if all configurations of a pre-defined set of configurations for said network element have been conducted, wherein said pre-defined set of configurations is smaller than a set of configurations that comprises all configurations that can be conducted for said network element; and means arranged for indicating an incomplete configuring of said network element, wherein said incomplete configuring of said network element is indicated in case said checking reveals that not all configurations of said pre-defined set of configurations have been conducted. Said device may for instance be a configuring device that can be connected via an interface to said network element to allow for said configuring of said network element. Equally well, said device may be a part of said configuring device or said network element.

It is further proposed a network element comprising means arranged for checking if all configurations of a pre-defined set of configurations for said network element have been conducted, wherein said pre-defined set of configurations is smaller than a set of configurations that comprises all configurations that can be conducted for said network element; and means arranged for indicating an incomplete configuring of said network element, wherein said incomplete configuring of said network element is indicated in case said checking reveals that not all configurations of said pre-defined set of configurations have been conducted. Said network element may for instance be any functional unit of a network, wherein said network may for instance be any wire-bound or wireless telecommunications system, or any wire-bound or wireless data transmission system such as a wire-bound or wireless local or wide area network. If said network is the Universal Mobile Telecommunications System (UMTS), said network elements may be nodes in a Radio Access Network (RAN) or Core Network (CN) of said UMTS, as for instance a Node B, a Radio Network Controller (RNC), an intermediate transmission node, a Mobile-Services Switching Center (MSC), a CN gateway or any other type of node.

It is further proposed a system, said system comprising a network element and a device connected to said network element, wherein said network element and said device jointly implement means arranged for checking if all configurations of a pre-defined set of configurations for said network element have been conducted, wherein said pre-defined set of configurations is smaller than a set of configurations that comprises all configurations that can be conducted for said network element; and means arranged for indicating an incomplete configuring of said network element, wherein said incomplete configuring of said network element is indicated in case said checking reveals that not all configurations of said pre-defined set of configurations have been conducted.

Said network element and said device do not necessarily have to be co-located. For instance, said device may be a part of a configuring device that is locally or remotely connected to said network element by means of a wireless or wire-bound connection.

These and other aspects of the invention will be apparent from and elucidated with reference to the embodiments described hereinafter.

### BRIEF DESCRIPTION OF THE FIGURES

In the figures show:

FIG. 1: A block diagram of an exemplary embodiment of a configuring device connected to a network element according to the present invention;

FIG. 2: a block diagram of an exemplary embodiment of a network element in a network according to the present invention;

FIG. 3: a flowchart of an exemplary embodiment of a method according to the present invention;

FIG. 4: an illustration of an indication of an incomplete configuring of a network element via a graphical user interface according to the present invention; and

FIG. 5: an illustration of a displaying of a list of not yet conducted configurations of a pre-defined set of configurations according to the present invention.

### DETAILED DESCRIPTION OF THE INVENTION

The present invention addresses the indication of a status of a configuring of network elements and proposes to check if all configurations of a pre-defined set of configurations for said network element have been conducted. Therein, said pre-defined set of configurations is smaller than a set of configurations that comprises all configurations that can be conducted for said network element. In case said check reveals that not all configurations of said pre-defined set of configurations have been conducted, an incomplete configuring of said network element is indicated.

In the following part of this detailed description, the present invention will be described by means of embodiments. It is to be understood that these embodiments are of exemplary nature and are by no means intended to limit the scope of the present invention.

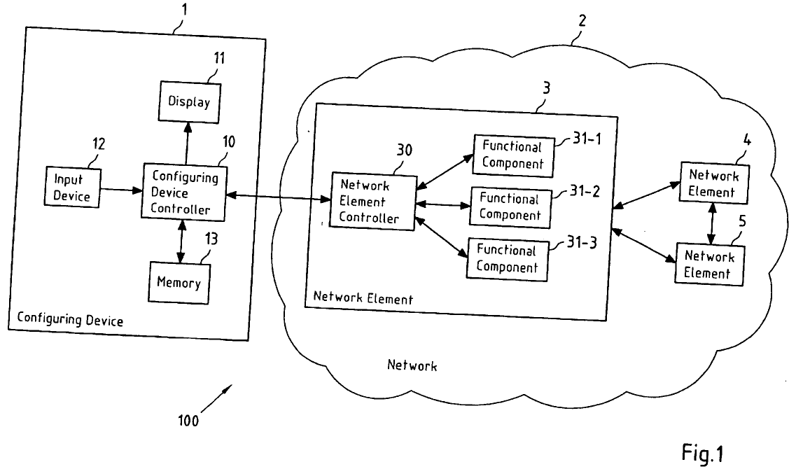

FIG. 1 depicts a block diagram of an exemplary embodiment of a configuring device 1 connected to a network element 3 according to the present invention. Said configuring device 1 and said network element 3 are comprised in a system 100. Therein, said network 2 comprises a plurality of network elements 3, 4 and 5. Said network elements 3, 4 and 5 are connected to each other by means of wireless and wire-bound connections and exchange information. Said information may be either user data or control data. For instance, said network may be a Radio Access System (RAN) of a mobile radio communications system like for instance the Universal Mobile Telecommunications System (UMTS), and then said network element 3 may for instance be a Node B (i.e. a base station) or a Radio Network Controller (RNC), and said network elements 4 and 5 may be intermediate transmission equipment. Only the components of network element 3 are shown in more detail, whereas it is readily understood that network elements 4 and 5 may also comprise further components that are not depicted in FIG. 1.

Network element 3 comprises a network element controller 30 for controlling a plurality of functional components 31-1 . . . 31-3, wherein said functional components 31-1 . . . 31-3 implement the functionality of said network element. In the exemplary case that said network element 3 is a Node B in a RAN, said functional components 31-1 . . . 31-3 may for instance implement functionality to enable radio connections between one or several User Equipments (i.e. mobile stations) and said Node B and to allow for a transfer of user and control data between said Node B and one or several RNCs. For instance, said functional component 31-1 may implement a synchronization functionality and may derive a synchronization from a synchronization source.

In FIG. 1, furthermore a configuring device 1 is depicted. This configuring device 1 may for instance be deployed when commissioning said network element 3 during the roll-out of said network 2. In the set-up of FIG. 1, it is assumed that said configuring device 1 is a unit that is at least functionally separated from said network element 3. It may for instance be temporarily connected to said network element for commissioning, or be continuously connected thereto. Therein, said connection between said configuring device 1 and said network element 3 may be a wireless or wire-bound connection, and said configuring device 1 and said network element may be either closely positioned, for instance in the same rack, or distantly positioned. In the latter case, then a remote configuring of said network element 3, for instance from a central configuring device 1 that is capable of configuring several spread network elements of one or several networks 2, may be possible.

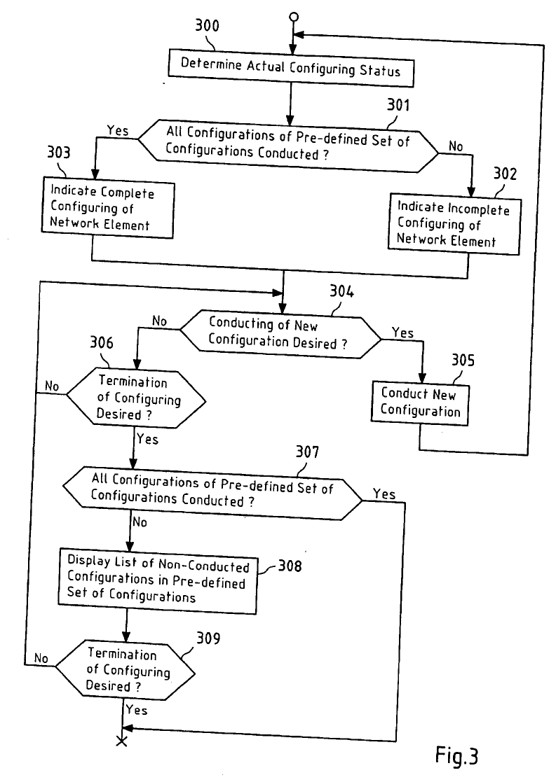

Said configuring device 1 comprises a configuring device controller 10 for controlling the configuring of at least said network element 3, a display 11 and an input device 12 as a human-machine-interface between said configuring device 1 and a user, for instance a commissioning engineer, and a memory 13. The components of said configuring device 1 are capable of performing the method steps according to the present invention, which will be explained with reference to the flowchart of FIG. 3 below. To this end, said configuring device may execute a computer program with instructions operable to cause said configuring device 1 to perform the method steps of the present invention. Said computer program may for instance be stored on a computer program product that is read by said configuring device 1.

In particular, said configuring device controller 10 is capable of checking if all configurations of a pre-defined set of configurations have been conducted for said network element 3, wherein, according to this exemplary embodiment of the present invention, said pre-defined set of configurations comprises configurations that have been determined to be important for the operation of said network element 3 and that may for instance be stored in said memory 13. This may for instance be determined in cooperation with the network element controller 30 of network element 3. Therein, configurations are understood to be conducted by defining one or more system parameters related to a specific function or property of said network element 3, for instance to a specific functional component 31-1 . . . 31-3 of said network element 3.

Furthermore, said display 11 of said configuring device, when being triggered by said configuring device controller 10, is capable of indicating an incomplete configuring of said network element 3, for instance via a Graphical User Interface (GUI), if it is determined that not all configurations of said set of configurations have been conducted. Said configurations may be conducted by a user by interaction with said input device 12, which may for instance be at least one of a keyboard, a voice control unit, a touch screen display, a mouse, a touch pad, a track pin or any other kind of interaction device, and a GUI displayed on said display 11 of said configuring device 1. It is readily clear that the configuring device may for instance be embodied as a desktop or lap-top computer.

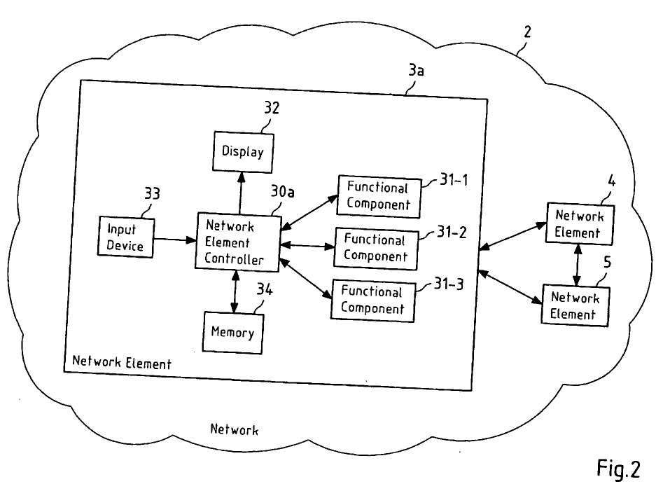

FIG. 2 depicts a block diagram of an exemplary embodiment of a network element 3a according to the present invention. Therein, elements of the block diagram of FIG. 2 that correspond to elements in the block diagram of FIG. 1 are denoted with the same reference numerals. The network element 3a is comprised in a network 2 together with network elements 4 and 5 it is connected to, wherein said network 2 may for instance be a RAN of the UMTS as in FIG. 1.

In contrast to the network element 3 of FIG. 1, the network element 3a of FIG. 2 also comprises the functionality of the configuring device 1 of FIG. 1. To this end, the network element 3a is furnished with a display 32, an input device 33 and a memory 34, and the network element controller 30a provides extended functionality as compared to the network controller 30 of FIG. 1. The network element controller 30a then is particularly capable of checking if all configurations of a pre-defined set of configurations, which may for instance be stored in memory 34, have been conducted for said network element 3a, and if this is not the case, an indication of an incomplete configuring of said network element 3a is indicated via a GUI that is displayed on display 32.

FIG. 3 depicts a flowchart of an exemplary embodiment of a method for indicating a status of a configuring of a network element according to the present invention. The steps 300-309 of this flowchart may for instance be executed by the device 1 of FIG. 1 or the network element 3a of FIG. 2 in real-time during a configuring of said network element 3 (FIG. 1) and 3a (FIG. 2), respectively, wherein said configuring may for instance be required during a commissioning of network elements or during a maintenance of said network element, for instance an exchange of hard- and/or software components.

If a configuring of a network element, i.e. a process of conducting a plurality of configurations for said network element, is started, an actual configuring status of said network element is determined in step 300. This step comprises at least checking which configurations for said network element have been conducted so far, regardless whether they have been conducted before said actual configuring of said network element, e.g. during a manufacturing of said network element or a previous configuring session, or during the present configuring of said network element. This may for instance be accomplished by checking for which system parameters of said network element values have been defined at all, regardless whether said definitions are correct and/or lead to operative configurations or not. According to the present invention, it is nevertheless also envisaged that step 300 also comprises a step of checking whether configurations that have been conducted so far are operative, and then only operative configurations are considered to have been conducted.

The actual configuring status of said network element that is output by step 300 then contains information on all configurations that have been conducted.

Based on said actual configuring status and a set of pre-defined configurations, it is then determined in a step 301 if all configurations of said pre-defined set of configurations have been conducted so far or not. Therein, the pre-defined set of configurations has been defined before said configuring of said network element, contains—in the present embodiment—only those configurations (of all possible configurations that are possible for said network element) that are considered to be important for an operation of said network element and may for instance be stored in a memory.

If step 301 produces a negative result, an incomplete configuring of said network element is indicated to a user in a step 302, for instance via a GUI that is displayed on the display 11 of FIG. 1 or the display 32 of FIG. 2. A user then is notified that not even the configurations of said pre-defined set of configurations have been conducted yet, so that the network element will be malfunctioning when the configuring is terminated without conducting further configurations. Said indication may be a persistent indication, i.e. it may be presented to a user until it is determined that all configurations of said pre-defined set of configurations have been performed. Equally well, said indication may only appear for a limited duration of time.

If it is determined in step 301 that all configurations of said pre-defined set of configurations have been conducted, a complete configuring of said network element is indicated in step 303. This may either be achieved implicitly by removing, if it is present, an indication of an incomplete configuring of said network element, or explicitly by displaying a graphical indication that said configuring is complete, for instance via a GUI that is displayed on the display 11 of FIG. 1 or the display 23 of FIG. 2. Therein, said indication of said incomplete configuring and said indication of said complete configuring may correspond to each other, for instance incomplete configuring may be indicated by a red button, and complete configuring may be indicated by a green button. Said indication of said complete configuring may also be either persistent or temporary.

In step 304, it is checked if the user wants to conduct new configurations, for instance in response to the indication of the incomplete configuring of said network element in step 302. This check may for instance be represented by waiting for an input of the user from said input device 12 of FIG. 1 or 33 of FIG. 2, or by explicitly asking a user by means of said GUI if new configurations shall be conducted or not.

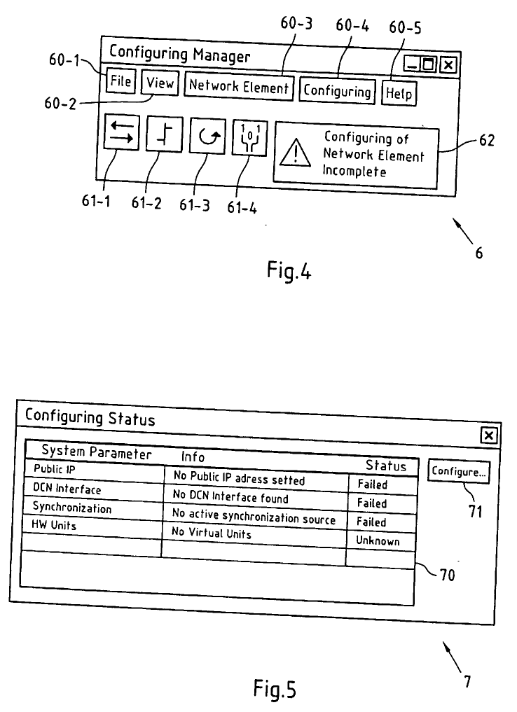

If a user wants to conduct new configurations, these new configurations can be conducted in step 305, for instance via a configuration dialogue that is offered to the user via the GUI. Said configuration dialogue may for instance be started by the user by selecting an option from a toolbar that is displayed via said GUI (see for instance the exemplary GUI 6 depicted in FIG. 4, which offers a pull-down menu 60-4 “Configuring”), or by selecting a button that is also used to indicate said incomplete configuring of said network element (see for instance the exemplary GUI 6 depicted in FIG. 4, which displays a button 62 as long as not all configurations of said pre-defined set of configurations have been conducted). When selecting said button, advantageously only a list of those configurations of said set of configurations that not have been conducted yet is presented to a user, so that the configurations that require to be conducted can be identified and selected quickly. An example of such a list will be described below with reference to FIG. 5.

After a new configuration has been conducted by the user in step 305, the flowchart loops back to step 300 and updates the actual configuring status, which may have changed due to said new configuration.

If it is determined in step 304 that no conducting of a new configuration is desired by a user, it is determined if a termination of the configuring is desired by the user or not in step 306. This may for instance be accomplished by waiting if a user selects a termination option, or by explicitly asking a user via the GUI if a termination of the configuring is desired or not.

If termination of the configuring is not desired by the user, the flowchart loops back to step 304. Otherwise, it is (again) determined in step 307 if all configurations of said pre-defined set of configurations have been conducted or not. If this is not the case, a list of those configurations of said pre-defined set of configurations that not yet have been conducted is presented to the user in step 308 (as for instance depicted in FIG. 5), so that a user can easily identify and then optionally select those configurations that still need to be conducted. After said displaying of said list of not yet conducted configurations, the user is then (again) asked in a step 309 if termination of the configuring is desired, although not all configurations of said pre-defined set of configurations have been conducted yet. If this not the case, the flowchart loops back to step 304, and the user is given opportunity to conduct further configurations. Otherwise, and also if the check in step 307 if all configurations of the pre-defined set of configurations have been conducted yields a positive result, the configuring terminates.

FIG. 4 represents an illustration of an indication 62 of an incomplete configuring of a network element via a GUI according to the present invention. The toolbar 6 as depicted in FIG. 4 represents a component of a GUI that is displayed to a user on a display, for instance the display 11 of FIG. 1 or the display 32 of FIG. 2.

Said toolbar 6 offers a plurality of pull-down menus 60-1 . . . 60-5 and a plurality of buttons 61-1 . . . 61-4 for user interaction. For instance, by selecting the “File” pull-down menu 60-1, a couple of operations related to file manipulation such as opening or storing configuration files may be available to a user. By selecting one of said buttons 61-1 . . . 61-4, functions may be invoked directly, such as for instance transferring a set of configurations to said network device that is to be configured, or invoking a configuring dialogue in which configurations for said network element can be conducted (see step 305 of the flowchart of FIG. 3). Said toolbar 6 itself may typically be invoked by a user when configuring of one or several network elements is desired.

According to the present invention, said toolbar 6 comprises a button 62 that serves to indicate that not all configurations of said pre-defined set of configurations have been performed yet. As long as said button 62 is displayed on said toolbar 6, a user is notified that not all configurations of said pre-defined set of configurations for said network element have been conducted so far. If all of said configurations of said pre-defined set of configurations have been conducted, said button 62 may either be removed to implicitly indicate a complete configuring of said network element, or may be changed into a button that explicitly indicates a complete configuring of said network element.

FIG. 5 is an illustration of a displaying of a list 70 of not yet conducted configurations of said pre-defined set of configurations according to the present invention. The displaying of said list 70 may for instance be invoked by selecting said button 62 of the toolbar 6 of FIG. 4, or automatically as in step 308 of the flowchart of FIG. 3. In FIG. 5, said list 70 is comprised in a GUI window 7 that is a part of the GUI that assists a user in the configuring of said network element. In said list 70, said configurations are represented by one or more system parameters. For instance, a configuration related to “IP Settings” is represented by system parameters “Public IP” and “DCN Interface”. A configuration related to “Synchronization” is represented by a system parameter “Synchronization”. In said list 70, also the configuring status for each listed system parameter is indicated in the right column, either as “Failed” or “Unknown”. Furthermore, the centre column of said list contains information related to the deficiency of the respective system parameter. For instance, in case of the system parameter “Public IP”, it is indicated that no public IP address has been defined at all, and in case of the system parameter “DCN Interface”, it is indicated that no DCN interface could be found. As can be readily seen, in case of the “Public IP” system parameter, it is only checked if any value has been defined for said system parameter (cf. step 300 in the flowchart of FIG. 3), whereas in case of the “DCN Interface” system parameter, it is also checked if this system parameter leads to an operative configuration, because a DCN interface has been defined, but this defined DCN interface is not functional, so that it should be re-defined.

When said list 70 is displayed to a user, the user then may select one of the entries of said list and hit the “Configure” button 71. This invokes a configuration dialogue in which the configuration related to the selected list entry can be (re-)conducted by the user.

According to the above-described exemplary embodiments of the present invention, the status of the configuring of the network element is always indicated to the user as button 62 on the toolbar 6 (see FIG. 4). The status of the configuring of the network element is thus always up-to-date, as it is continuously checked (for instance in real-time) during the configuring process (cf. the flowchart of FIG. 3), and makes sure that all configurations in said pre-defined set of configurations are conducted during said configuring, which may either take place in a commissioning of said network element or in a maintenance of said network element. The configuring thus gets more robust and less error-prone even if it is performed by less experienced users. The present invention may substantially be implemented in software, for instance by upgrading existing configuration software, and thus can be realized with comparatively low costs. Furthermore, legacy configuring devices and/or network elements can thus be easily upgraded to perform the method of the present invention.

The present invention has been described above by means of exemplary embodiments. It should be noted that there are alternative ways and variations which are obvious to a skilled person in the art and can be implemented without deviating from the scope and spirit of the appended claims. In particular, the present invention is by no means restricted to deployment in network elements of mobile radio communications systems only, it can equally well be deployed for the configuration of network elements in all other types of networks as for instance wire-bound telecommunications systems and all types of data transmission systems.

1. A method for indicating a status of a configuring of a network element, said method comprising:
checking if all configurations of a pre-defined set of configurations for said network element have been conducted, wherein said pre-defined set of configurations is smaller than a set of configurations that comprises all possible configurations for said network element; and
indicating an incomplete configuring of said network element when said checking reveals that not all configurations of said pre-defined set of configurations have been conducted.

2. The method according to claim 1, wherein said configurations in said pre-defined set of configurations are important for an operation of said network element.

3. The method according to claim 1, wherein said checking if all configurations of said pre-defined set of configurations for said network element have been conducted comprises:
checking if at least one configuration of said pre-defined set of configurations is operative, wherein said at least one configuration of said pre-defined set of configurations is only considered to have been conducted if it is operative.

4. The method according to claim 1, wherein said checking if all configurations of said pre-defined set of configurations for said network element have been conducted and said indicating of an incomplete configuring of said network element in case said checking reveals that not all configurations of said pre-defined set of configurations have been conducted are performed automatically during said configuring of said network element.

5. The method according to claim 1, wherein said indicating of said incomplete configuring of said network element is performed as long as said checking reveals that not all configurations of said pre-defined set of configurations have been conducted.

6. The method according to claim 1, wherein said checking if all configurations of said pre-defined set of configurations for said network element have been conducted is repeated each time a configuration for said network element is conducted.

7. The method according to claim 1, wherein said method is performed during a commissioning of said network element.

8. The method according to claim 1, wherein said method is performed during a maintenance of said network element.

9. The method according to claim 1, wherein said incomplete configuring of said network element is indicated via a graphical user interface that is used for said configuring of said network element.

10. The method according to claim 9, wherein said incomplete configuring of said network element is indicated via a dedicated graphical element of said graphical user interface.

11. The method according to claim 1, further comprising:
indicating a complete configuring of said network element if said checking reveals that all configurations of said pre-defined set of configurations have been conducted.

12. The method according to claim 1, further comprising:
displaying, on demand, a list of the configurations of said pre-defined set of configurations that not have been conducted yet.

13. The method according to claim 1, further comprising:
displaying a list of the configurations of said pre-defined set of configurations that have not been conducted when said configuring of said network element is terminated.

14. The method according to claim 12, further comprising:
displaying a configuration dialogue that assists a user in conducting at least one configuration of the configurations of said pre-defined set of configurations that not have been conducted, if said at least one configuration is selected from said list.

15. A computer program embodied within a computer readable medium, the computer program being configured to perform the steps of:
checking if all configurations of a pre-defined set of configurations for said network element have been conducted, wherein said pre-defined set of configurations is smaller than a set of configurations that comprises all possible configurations for said network element; and
indicating an incomplete configuring of said network element when said checking reveals that not all configurations of said pre-defined set of configurations have been conducted.

16. A computer program product embodied within a computer readable medium, the computer program being configured to perform the steps of:
checking if all configurations of a pre-defined set of configurations for said network element have been conducted, wherein said pre-defined set of configurations is smaller than a set of configurations that comprises all possible configurations for said network element; and
indicating an incomplete configuring of said network element when said checking reveals that not all configurations of said pre-defined set of configurations have been conducted.

17. A device, comprising:
means arranged for checking if all configurations of a pre-defined set of configurations for said network element have been conducted, wherein said pre-defined set of configurations is smaller than a set of configurations that comprises all possible configurations for said network element; and
means arranged for indicating an incomplete configuring of said network element, wherein said incomplete configuring of said network element is indicated when said checking reveals that not all configurations of said pre-defined set of configurations have been conducted.

18. A network element, comprising:
means arranged for checking if all configurations of a pre-defined set of configurations for said network element have been conducted, wherein said pre-defined set of configurations is smaller than a set of configurations that comprises all possible configurations for said network element; and
means arranged for indicating an incomplete configuring of said network element, wherein said incomplete configuring of said network element is indicated when said checking reveals that not all configurations of said pre-defined set of configurations have been conducted.

19. A system, comprising:
a network element; and
a device connected to said network element;
wherein said network element and said device jointly implement:
means arranged for checking if all configurations of a pre-defined set of configurations for said network element have been conducted, wherein said pre-defined set of configurations is smaller than a set of configurations that comprises all possible configurations for said network element; and
means arranged for indicating an incomplete configuring of said network element, wherein said incomplete configuring of said network element is indicated when said checking reveals that not all configurations of said pre-defined set of configurations have been conducted.
